(19) United States
(12) Patent Application Publication
(10) Pub. No.: US 2022/0342403 A1
(43) Pub. Date: Oct. 27, 2022

(54) SYSTEM AND METHOD FOR ASSESSING THE EFFECTIVENESS OF AUTOMATION SYSTEMS IMPLEMENTED IN A BUILDING

(71) Applicant: AVIGNAAI PRIVATE LIMITED, Pune (IN)

(72) Inventors: Sudhi Ranjan Sinha, Pune (IN); Nambivel Raj, Pune (IN); Jayesh Shirish Patil, Pune (IN)

(21) Appl. No.: 17/725,731

(22) Filed: Apr. 21, 2022

(30) Foreign Application Priority Data
Apr. 22, 2021 (IN) 202121012150

(51) Int. Cl. G05B 23/02

(52) U.S. Cl. CPC G05B 23/021

(57) ABSTRACT

A system and method for assessing the effectiveness of automation and control units (HVAC, Elevator, water supply, etc.) implemented in a Building Management System (BMS) of a building is illustrated. Initially, the system reads/receives a metadata corresponding to all the sensing and control requirements based on the design and usage of the building, and further, assesses the implementation of the control routines for determining how the automation objectives are being met in the building by each of the currently implemented automation and control units in the building. The system further assesses how all the automation and control units work together in tandem. This assessment is then interpreted on based on different vectors. Finally, the system identifies gaps based on the assessment and generates recommendations to address these gaps.

### TECHNICAL FIELD

The present subject matter described herein, in general, relates to a system and a method for assessment of a set of automation and control units. More specifically, the present subject matter discloses the system and method for assessment of the set of automation and control units implemented in a building.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the past century, starting with temperature control, many automation and control units have been introduced to manage the operations and maintenance activities in buildings. These automation and control units are collectively referred as a building management system (BMS). These automation and control units include heating, ventilation, and air conditioning (HVAC) systems, security systems, lighting systems, water management systems, waste management systems, sewage management systems, electricity management systems, Elevator management systems, solar management systems, and many more. Today, we have very sophisticated IoT-enabled control systems for controlling the day-to-day operations of each of these automation systems that are implemented in a building. The building owners/operators spend large sums of time and money towards the implementation and maintenance of such systems.

However, despite the adaptation of such sophisticated IoT-enabled control systems, most buildings suffer from gaps with the implementation and usage of such control systems. These gaps may arise due to improper coordination between independent automation and control systems in a building. These gaps may also arise due to missing sensors, improperly commissioned sensors and systems, non-implementation of control algorithms, and improper collaboration between all the sub-systems in the building.

To address these problems, time to time audits of individual control systems in the buildings are conducted by different audit agencies. However, these audits are performed in silos, wherein each auditing agency shares limited information with other agencies. Due to this, a lot of buildings suffer from fundamental structural flaws in the effective implementation of the control system.

Thus, there is a long-felt need for a system that can allow for easy and collective audit of all the control and automation systems, to identify gaps and suggest appropriate action to address these gaps.

### SUMMARY

This summary is provided to introduce concepts related to a system and method for assessing the effectiveness of automation systems implemented in a building, and the concepts are further described below in the detailed description. This summary is not intended to identify essential features of the claimed subject matter nor is it intended for use in determining or limiting the scope of the claimed subject matter.

One implementation of the present disclosure is a system for assessment of automation and control units (HVAC, Elevator, water supply, etc.) that are implemented in a Building Management System (BMS) of a building. Initially, the system is configured to determine all the sensing and control requirements based on the design and usage of the building. Further, the system is configured to assess the implementation of the control routines for determining how the automation objectives are being met in the building by each of the automation and control units that are currently implemented in the building. The system is also configured to assess how all the automation and control units work together in tandem. This assessment is then interpreted based on different vectors, for example—‘a) Does the building have the right kind of sensors and systems? b) Are the sensors and systems rightly configured? c) Have the right set of control algorithms been applied? d) Is the building fully optimized? and e) Is the building adaptive to changing environmental or usage parameters?’. Finally, the system is configured to identify gaps based on the assessment and generate recommendations to address these gaps.

For achieving this, the system comprises of a memory and a processor coupled to the memory, wherein the processor is configured to execute programmed instructions stored in the memory. The processor is configured for receiving metadata corresponding to a building, wherein the metadata corresponds to a location of the building, type of the building, a set of automation systems and a set of sub-systems implemented in the building. Further, the processor is equipped for analysing the metadata corresponding to the building, based on a set of predefined parameters, to identify a building template applicable to the building. The building template corresponds to a set of questions associated with the set of automation systems implemented in the building. Furthermore, the processor is enabled for receiving inputs, from a building automation system or derivative thereof, corresponding to each question from the set of questions. The set of questions correspond to the set of automation systems, System Control Routines corresponding to each automation system from the set of automation systems, the set of sub-systems corresponding to each automation system from the set of automation systems, Control Points corresponding to each sub-system from the set of sub-systems, Control Routines corresponding to each sub-system from the set of sub-systems, and Adaptive Control Routines corresponding to each sub-system from the set of sub-systems. The processor is further configured for building a system tree corresponding to the building based on the inputs received from the building automation system. The system tree may be built using a neural network. The processor is further configured for generating a set of assessment question based on metadata and system tree and receiving inputs from the building automation system corresponding to the set of assessment questions. Further, the processor is configured for calculating an automation effectiveness score corresponding to each system and sub-system in the building, based on the received inputs from the building automation system on the set of assessment questions. The processor is further configured for determining the impact of altering one or more parameters on the automation effectiveness score corresponding to each system and sub-system in the building. Furthermore, the processor is configured for generating a set of recommendations for improving automation effectiveness and building operations based on the impact of altering one or more parameters.

### BRIEF DESCRIPTION OF DRAWINGS

The detailed description is described with reference to the accompanying Figures. The same numbers are used throughout the drawings to refer like features and components.

FIG. 1 illustrates a network implementation 100 of a system 101 for assessment of automation and control units implemented in a Building Management System (BMS) of a building, in accordance with an embodiment of the present disclosure.

FIG. 2 illustrates block diagram 200 of the system 101, in accordance with an embodiment of the present disclosure.

FIG. 3a illustrates a symbolic representation for a list and organization 300a of various constituent operational building systems for capturing information corresponding to a Building Management System (BMS) 105, in accordance with an embodiment of the present disclosure.

FIG. 3b illustrates HVAC Mechanical Controls 300b corresponding to a Building Management System (BMS) 105, in accordance with an embodiment of the present disclosure.

FIG. 3c illustrates Non-HVAC Controls 300c corresponding to a Building Management System (BMS) 105, in accordance with an embodiment of the present disclosure.

FIG. 4 illustrates a block diagram 400 of a Heating Ventilation and Air Conditioning (HVAC) system of the building, in accordance with an embodiment of the present disclosure.

FIG. 5 illustrates a method 500 for assessment of automation and control units implemented in a building, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

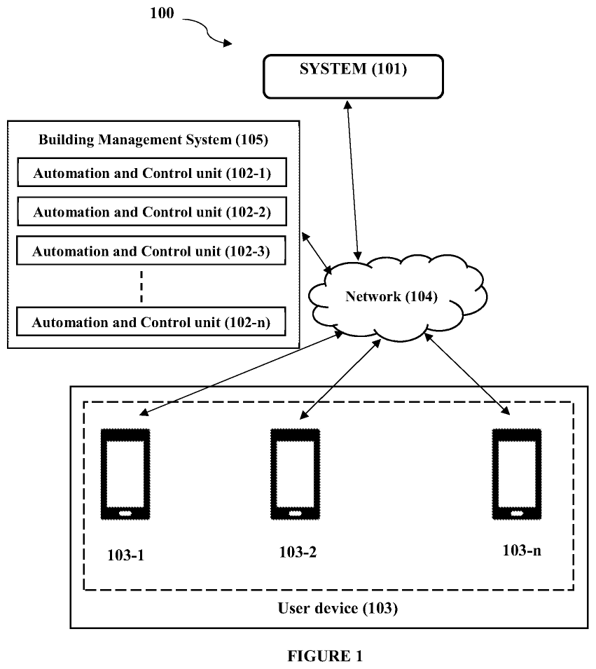

Referring to FIG. 1, implementation 100 of system 101 for assessment of automation and control units that are part of a Building Management System 105 in a building is illustrated, in accordance with an embodiment of the present subject matter. In one embodiment, the system 101 may comprise a processor and a memory. Further, the system 101 may be connected to user devices through a network 104. It may be understood that the system 101 may be communicatively coupled with multiple users through one or more user devices 103-1, 103-2, 103-3 . . . , 103-n collectively referred to as a user device 103. Further, the system 101 may be communicatively connected to one or more automation and control units 102-1, 102-2, 102-3 . . . , 102-n collectively referred to as automation and control units 102. In one embodiment, the user devices 103 may be used by operators/stakeholders of different automation and control units 102 for manually entering data corresponding to the automation and control units 102 if there is no communication channel between the system 101 and the automation and control units 102 for auto capturing of data.

In one embodiment, the network 104 may be a cellular communication network used by user devices 103 such as mobile phones, tablets, or a virtual device. In one embodiment, the cellular communication network may be the Internet. The user device 103 may be any electronic device, communication device, image capturing device, machine, software, automated computer program, a robot or a combination thereof.

Further the automation and control units 102 may be include heating, ventilation, and air conditioning (HVAC) systems, security systems, Lighting systems, water management systems, waste management systems, sewage management systems, electricity management systems, Elevator management systems, solar management systems, or any other control platform implemented in the building.

In one embodiment, the user devices 103 used for collecting data corresponding to the automation and control units 102 may support communication over one or more types of networks in accordance with the described embodiments. For example, some user devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G, 5G, 6G), a radio network, a television network, a cable network, an optical network (e.g., PON), a satellite network (e.g., VSAT), a packet-switched network, a circuit-switched network, a public network, a private network, and/or other wired or wireless communications network configured to carry data.

The aforementioned user devices 103 and network 104 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

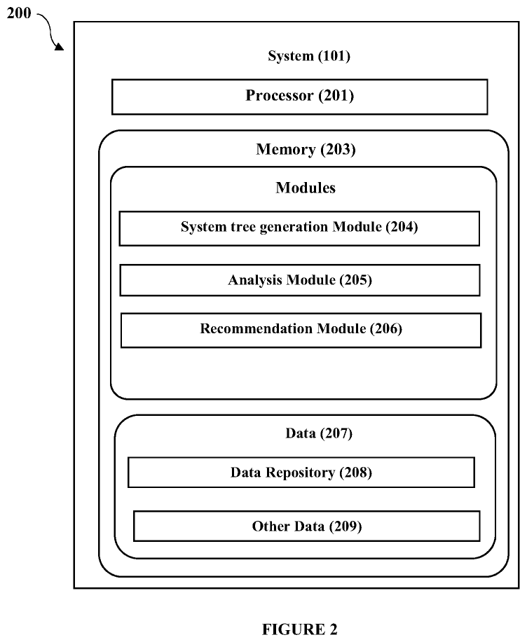

In one embodiment, the automation and control units 102 may be integrated with IoT systems associated with the Building Management System (BMS) such that the IoT systems capture data automatically and transmit the data to the system 101. The system 101 for assessment of automation and control units implemented in the Building Management System (BMS) of the building is further illustrated with the block diagram in FIG. 2.

Referring now to FIG. 2, block diagram 200 comprising various components of the system 101 is illustrated, in accordance with an embodiment of the present subject matter. As shown, the system 101 may include at least one processor 201 and a memory 203. The memory consists of a set of modules. The set of modules may include a System tree generation module 204, an analysis module 205, and a recommendation module 206. In one embodiment, the at least one processor 201 is configured to fetch and execute computer-readable instructions, stored in the memory 203, corresponding to each module.

In one embodiment, the memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions 205 may include routines, programs, objects, components, data structures, etc., which perform particular tasks, functions, or implement particular abstract data types. The data 207 may comprise a data repository 208, and other data 209. The other data 209 amongst other things, serves as a repository for storing data processed, received, and generated by one or more components and programmed instructions. The working of the system 101 will now be described in detail referring to FIGS. 1 and 2.

In one embodiment, the processor 201 may be configured for executing programmed instructions for receiving a metadata corresponding to a building, wherein the metadata corresponds to a location of the building, type of the building and a set of automation systems and a set of sub-systems implemented in the building. Further, the processor 201 may be configured for analysing the metadata corresponding to the building, based on a set of predefined parameters, to identify a building template applicable to the building, wherein the building template corresponds to a set of questions associated with the set of automation systems implemented in the building. Furthermore, the processor 201 may be configured for receiving inputs, from a building automation system, corresponding to each question from the set of questions, wherein the set of questions correspond to a set automation systems, System Control Routines corresponding to each automation system from the set of automation systems, a set of sub-systems corresponding to each automation system, Control Points corresponding to each sub-system from set of sub-systems, Control Routines corresponding to each sub-system from set of sub-systems, and Adaptive Control Routines corresponding to each sub-system from set of sub-systems.

In another embodiment, the processor 201 may be configured for executing programmed instructions corresponding to system tree generation module 204 for generating a system tree. For this purpose, the system tree generation module 204 may generate a series of questions to capture information corresponding to the automation and control units 102 associated with the building. It may be understood by a person skilled in the art that the series of questions may be in the form of data points request triggered to the building automation system. Based on the information captured from the building automation system, a system tree may be generated as follows:

The system tree:
a. Chilled Water Distribution
   i. Air Cooled
   ii. Water Cooled
   iii. Vapor Absorption
b. Direct Expansion
   i. Variable Refrigerant Flow
   ii. Air Cooled Condenser
      1. Roof Top Unit
      2. Window Room Air Conditioning
      3. Split Units
      4. Ducted Split Units
   iii. Water Cooled Condenser—Water Cooled Package Units
c. Evaporative Air Conditioning
d. Geothermal Air Conditioning

As represented above, the system tree may be a hierarchical representation of the primary HVAC automation and control units 102 that are implemented in the building. Similar system trees for other building systems might be generated as well.

Once the system tree is generated, in the next step, the analysis module 205 may generate one or more question corresponding to the system design based on the metadata and system tree, and receive inputs from the building automation system corresponding to the system design. For example, the set of questions may be designed to capture type, size/capacity, numbers, age, and the like associated with a Chilling unit in the Building Management System (BMS). Another set of questions may be configured to capture details corresponding to VSD usage, building electricity load, and the like. All these questions may be triggered to the User Devices 103 associated with the Building Management System (BMS) and accordingly inputs may be captured from the Building Management System (BMS). Alternately, the one or more questions may directly be triggered to the Building Management System (BMS), and the Building Management System (BMS) may respond to the one or more questions using Application Program Interfaces (API's).

Further the analysis module 205 may generate one or more question corresponding to the sensors and devices commissioned and associated points commissioned in the Building Management System (BMS) based on the metadata and the system tree. Further the analysis module 205 may capture inputs corresponding to sensors and devices commissioned and associated points commissioned in the Building Management System (BMS). The information captured by the analysis module 205 may be represented in a tabulated format as represented in table 1.

TABLE 1
List of sensors and devices commissioned,
and associated points commissioned.

| Devices | Edge Points |
|---|---|
| Immersion Temperature Sensor | CH# Chilled Water Supply Temp |
| Immersion Temperature Sensor | CH# Chilled Water Return Temp |
| Differential Pressure Sensor | CH# Chilled Water Supply Pressure |
| Differential Pressure Sensor | CH# Chilled Water Return Pressure |
| Differential Pressure | CH# Chilled Water DP |
| Magflow Transmitter | CH# Chilled Water Flow |
| Setpoint | CH# Chilled Water Flow Setpoint |
| Setpoint | CH# Maintenance Switch |
| Electrical Meter | CH# Energy Consumption & Power |
| Electrical Meter | CH# Chilled Water Pump Active Power |
| Electrical Meter | CH# Chilled Water Pump Energy |
| | Consumption |
| VSD | CH# Chilled Water Pump Active Power |
| VSD | CH# Chilled Water Pump Energy |
| | Consumption |
| VSD | CH# Chilled Water Pump Variable |
| | Speed Drive |
| Chiller | CH# LCHWT Set-point Reset Signal |
| Chiller | CH# FLA % Set-point Reset Signal |
| Calculated Software Point | CH# Heat Balance |
| Calculated Software Point | CH# Chiller efficiency |
| Calculated Software Point | CH # Chiller Cooling Load |
| Calculated Software Point | CH # Delta Temp Chilled Water |
| | Supply & Chilled Water Return |
| Calculated Software Point | CH# Delta Pressure Chilled Water |
| | Supply & Chilled Water Return |
| Calculated Software Point | Cooling Call |
| Immersion Temperature Sensor | Header Chilled Water Supply |
| | Temperature |
| Immersion Temperature Sensor | Header Chilled Water Return |
| | Temperature |
| Magflow Transmitter | Header Chilled Water Flow rate |
| Control Valve & Actuator | Header Chilled Water Bypass Valve |
| Weather Station | Weather Station (Dry Bulb Temp & |
| | Relative Humidity) |
| Calculated Software Point | Header Delta Temp Chilled Water |
| | Supply & Chilled Water Return |
| Differential Pressure Sensor | Delta Pressure Chilled Water Supply & |
| | Chilled Water Return |
| Electrical Meter | Main Switchboard Active Power |
| Electrical Meter | Main Switchboard Energy Consumption |
| Calculated Software Point | Chiller Plant Heat Balance |
| Calculated Software Point | Chiller Plant Cooling Load |
| Calculated Software Point | Chiller Plant Efficiency |
| Calculated Software Point | Chilled Water Pumps Efficiency |
| Chiller | CH# Information (Bacnet HLI) |

Further, the analysis module 205 may generate one or more question corresponding to the control algorithms implemented in the Building Management System (BMS) 105 based on the metadata and the system tree. Further, the analysis module 205 may capture inputs corresponding to the control algorithms implemented in the Building Management System (BMS) 105. The list of control algorithms may be represented as below.

List of control algorithms implemented:
Chiller Staging Control
Chiller Sequencing on equal runtime
Variable Primary Pump Speed Control
Condenser Water Pump Speed Control
Cooling Tower Low Flow Bypass Valve Control
Cooling Tower Fans speed control
Cooling Tower #Sequencing on equal runtime
Pump only Control
Chilled water bypass valve control
Chilled Water Supply Temperature Reset based on Max CHW Valves
Primary Flow Setpoint Reset for Primary Pumps
Condenser Water DP/Flow Setpoint Reset based on Design Chiller Load
Condenser water supply temperature Setpoint Reset OA-WT
Minimizing Primary Pump power consumption
Minimizing Chiller power consumption
Minimizing Condenser Pump power consumption
Minimizing Cooling Tower Fan power consumption
Run hours optimization

Further, the analysis module 205 may discover the optimization routines deployed in the Building Management System (BMS) 105 based on an interactive question and answer system in which the analysis module 205 receiving the list of optimization routines based on the system tree generated as described earlier. The analysis module 205 upon receiving inputs from the computing device based on the sets of assessment questions, analyses the answers/inputs based on which there may be calculation of an automation effectiveness score. In one embodiment of this system, there may be a direct connection between the automation effectiveness assessment system and the Building Management System 105. Further, analysis module 205 may also discover the optimization routines deployed by directly reading the tables and repositories of the BMS.

The automation of a building works on the principle of achieving the objective of optimal use of both assets such as HVAC equipment and/or other building systems, and resources such as electricity and/or water while maintaining optimal comfort, health, safety, sustainability, and secure environment for the occupants. Such optimality is automatically calibrated by the building automation system. Such an optimality computation is done by the Automation Effectiveness System described as a part of this embodiment.

Furthermore, the analysis module 205 may calculating automation effectiveness of the Building Management System (BMS) 105 based on the following methodology:
a. Depending on the metadata of the building (such as its location, temperature zone, usage, occupancy, etc.) and the System Tree generated as described above, the optimal number of sensors, systems, commissioned points, and optimization routines will be determined.
b. The Automation Effectiveness Assessment System will assign relative weightages to the various sensors, systems, and optimization routines. This assignment will follow the path to achieving the optimal outcomes as described above.
c. The presence or lack thereof will attract a score by each sensor, each system, and each optimization routine.
d. The composite scope of automation effectiveness will be calculated by tabulating the weighted average scope of all the sensors, systems, and optimization routines.

The calculation of the automation effectiveness score may be corresponding to each system and sub-system in the building, based on the received inputs from the Building Management System (BMS) 105 corresponding to the set of assessment questions. The analysis module 205 may be further configured for determining impact of altering one or more parameters on the automation effectiveness score corresponding to each system and sub-system in the building.

Further based on the above information, the Recommendation Module 206 may generate a detailed set of recommendations for improving automation effectiveness and building operations. These set of recommendations may also be generated based on the impact of altering one or more parameters. The Recommendation Module 206 may also prepare a preliminary business case for the improvement initiative in the Building Management System (BMS) 105 based on what sensors, systems, and optimization routines have been missed out, incorrectly commissioned, or inappropriately linked to each other.

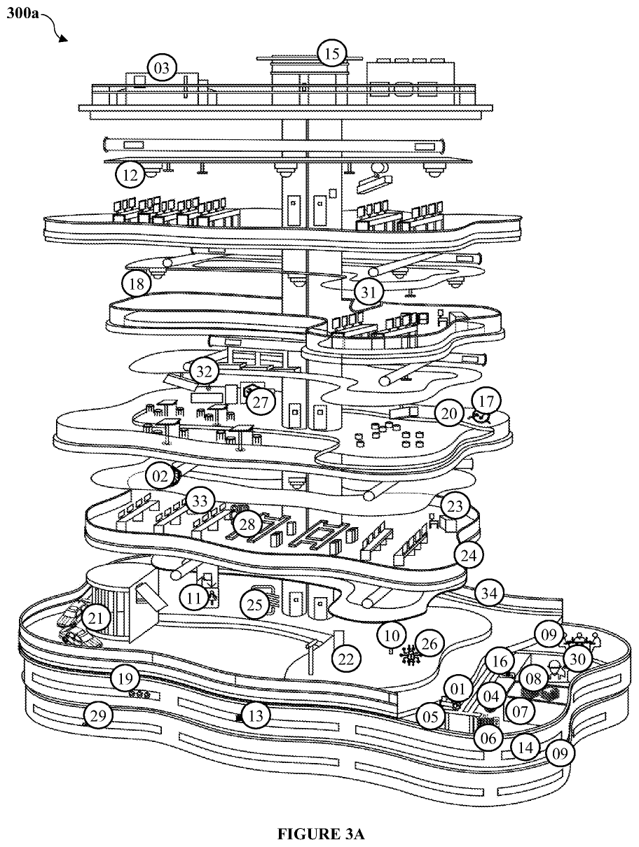

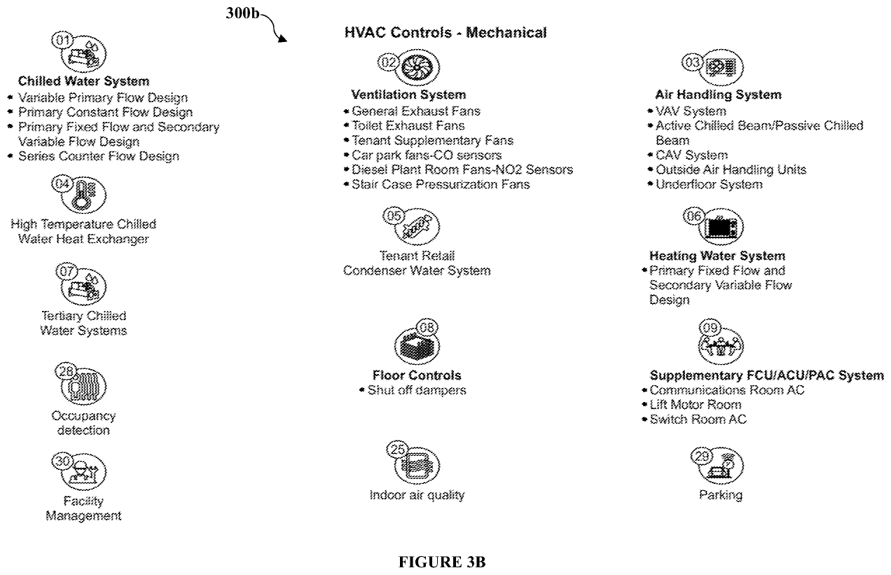

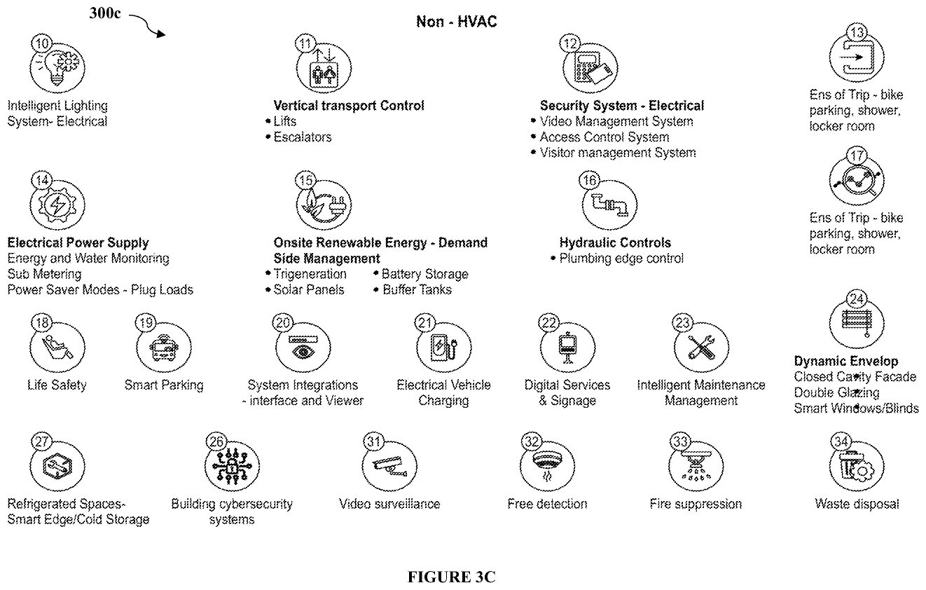

The exemplary embodiments of the Building Management System (BMS) 105 are now explained with reference to FIGS. 3a, 3b, 3c, 4, and 5.

FIGS. 3a represents a symbolic representation for a list and organization 300a of various constituent operational building systems shown in FIGS. 3b and 3c for capturing information corresponding to a Building Management System 105, in accordance with an embodiment of the present disclosure. 300a is a user-friendly diagrammatic representation of the Building Management System 105 showing an isometric/3D view of the building with various floor functionalities and systems. Further, various HVAC mechanical systems and non-HVAC systems are illustrated by numerals or numeral icons on the user interface as 01-34, while representing the list and organization 300a for the Building Management System 105. This representation may be in the form of encircled numerals as shown in the FIG. 3a or as per the user's display settings for the user interface.

Now, referring FIGS. 3b and 3c, HVAC Mechanical Controls 300b and Non-HVAC Controls 300c, corresponding to a Building Management System (BMS) 105, are illustrated. The Building Management System 105 may comprise one or more automation and control units 102. These automation and control units 102 may be represented in the form of icons on a user interface as represented in the FIGS. 3b and 3c. The user may view or select one or more icons and enter data corresponding to one or more automation and control units 102. The icons on the user interface may represent various HVAC systems corresponding to the Building Management System (BMS) 105 including, but not limited to, chilled water system 01, ventilation system 02, air handling system 03, heating water system 06, other supplementary systems 09 or the like, as shown in FIG. 3b. Further, the icons in the user interface may represent various Non-HVAC systems corresponding to the Building Management System (BMS) 105 including, but not limited to, various IoT (Internet-of-Things) systems like intelligent lighting 10, etc., electrical power supply 14, electrical security systems 12, smart parking system 19, intelligent maintenance management systems 23, digital services systems 22, vertical transport systems 11, hydraulic controls 16 or the like, as shown in FIG. 3c. In another embodiment, a set of questions/queries may be directly triggered to the Building Management System 105, and the Building Management System 105 may provide appropriate inputs corresponding to the one or more automation and control units 102. In order to fetch inputs from the one or more automation and control units 102, one or more API's may be implemented at the corresponding to one or more automation and control units 102 for capturing data automatically. Based on the inputs provided by the user and/or the one or more automation and control units 102 directly, the system 101 may generate a block diagram of different automation and control units 102 that are part of the Building Management System 105.

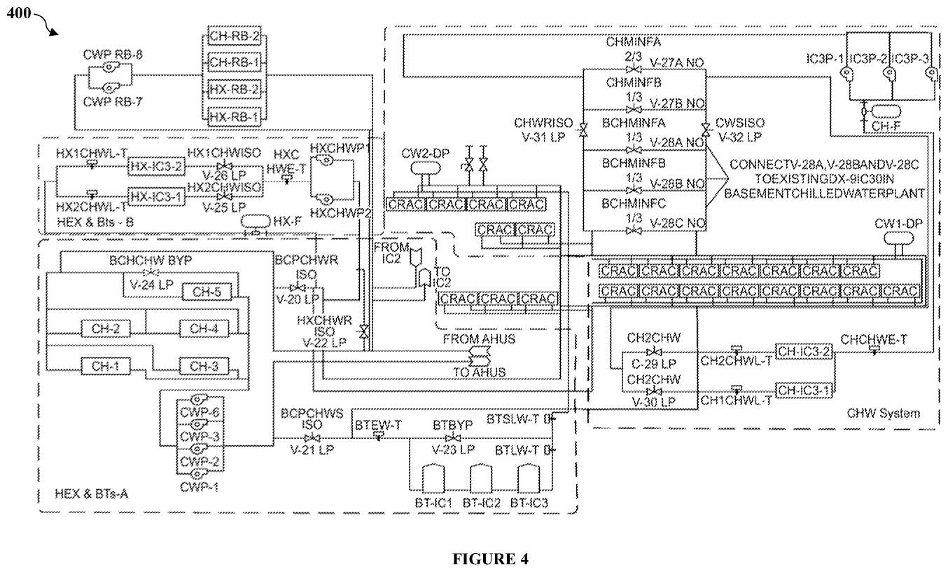

FIG. 4 illustrates a block diagram 400 of an air handling unit (AHU) like a Heating Ventilation and Air Conditioning (HVAC) system of the building that is generated based on the information captured from the user or automatically from the Building Management System (BMS) 105. The block diagram may be generated based on the inputs received from the building automation system. The HVAC block diagram shows an automated conventional building HVAC system comprising chilled water system, heat exchanger systems, and other various HVAC components like pumps, chillers, sensors, etc. connected with the Building Management System (BMS) 105.

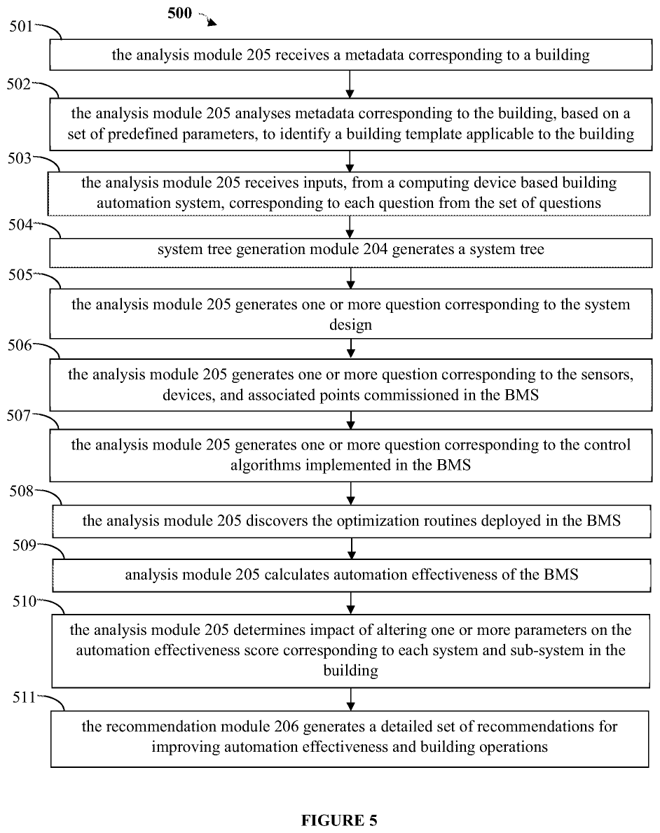

Now referring to FIG. 5, a method 500 for assessment of the set of automation and control units implemented in a building is illustrated, in accordance with an embodiment of the present subject matter.

At step 501, the analysis module 205 may receive a metadata corresponding to a building, wherein the metadata corresponds to a location of the building, type of the building and a set of automation systems and a set of sub-systems implemented in the building.

At step 502, the analysis module 205 may analyse the metadata corresponding to the building, based on a set of predefined parameters, to identify a building template applicable to the building, wherein the building template may correspond to a set of questions associated with the set of automation systems implemented in the building.

At step 503, the analysis module 205 may receive inputs, from a building automation system or derivative thereof, corresponding to each question from the set of questions, wherein the set of questions correspond to the set automation systems, System Control Routines corresponding to each automation system from the set of automation systems, a set of sub-systems corresponding to each automation system from the set automation systems, Control Points corresponding to each sub-system from the set of sub-systems, Control Routines corresponding to each sub-system from the set of sub-systems, and Adaptive Control Routines corresponding to each sub-system from the set of sub-systems.

At step 504, the system tree generation module 204 may generate a system tree. For this purpose, the system tree generation module 204 may generate a series of questions to capture information corresponding to the automation and control units 102 associated with the building.

At step 505, the analysis module 205 may generate one or more question corresponding to the system design and receive inputs from the building automation system corresponding to the system design.

At step 506, the analysis module 205 may generate one or more question corresponding to the sensors and devices commissioned and associated points commissioned in the Building Management System (BMS) 105 and capture inputs corresponding to the sensors and devices commissioned and associated points commissioned in the Building Management System (BMS) 105.

At step 507, the analysis module 205 may generate one or more question corresponding to the control algorithms implemented in the Building Management System (BMS) and capture inputs corresponding to the control algorithms implemented in the Building Management System (BMS) 105.

At step 508, the analysis module 205 may discover the optimization routines deployed in the Building Management System (BMS) 105.

At step 509, the analysis module 205 may calculating automation effectiveness of the Building Management System (BMS) 105.

Further, the analysis module 205 may use the following functions and equations for calculating the automation effectiveness of the Building Management System (BMS) 105, which may be, for ease of computation, considered here as Building Automation Performance Index (BAPI):

Energy Utilization Factor based Rating:

| Value | |
|---|---|
| (Energy Utilization Factor) | Energy Rating |
| ≤−5 | 1 |
| −4.9 ≤ −2 | 2 |
| −1.9 ≤ 0 | 3 |
| 0-2 | 4 |
| 2.1-5 | 5 |

Building Automation Performance Index (BAPI):

$$B API ( \frac{DoD Value}{Maximum} ) + ( \frac{Comfort Value}{Maximum} ) + ( \frac{Energy Rating}{Maximum} ) + ( \frac{Cost Value}{Maximum} ) + ( \frac{Efficiency of A , B , C , D , E , F}{100} )$$

BAPI Key Parameters:
1. Interoperability (Domain of Domain—DoD)
2. Personnel Comfortness (Ease of Operation and Maintenance System)
3. Energy Utilization Ratio (Power Demand vs Energy Consumption)
4. Cost (Life Cycle Cost—Investment, Operation, Maintenance Cost)
5. Building Component Efficiency—Device/Sensor, Points, Algorithms, Routines, etc.
   BAPI=function (Int, Com, Energy, Cost, Efficiency)
1. DoD Interoperability (Rating Value as 1-5):

| Rating Value | Description |
|---|---|
| 1 | No Interoperation/Standalone |
| 2 | Major System Integration (HVAC, Security, etc) |
| 3 | Major System Integration (H, S, L) |
| 4 | Key Major System Integration |
| 5 | Full Interoperability of all Domains |

2. Personnel Comfortness (Ease of Operation and Maintenance System)

$$Comfortness = {\sum }_{i = 1}^{n} Comfort of all Domains$$

n—number of domains/systems
(n=1—Basic/Manual
n=2—Semi Automatic
n=3—Fully Automatic)
3. Energy Utilization Ratio (Power Demand vs Energy Consumption)

$$Utilization = ( \frac{{P}_{D}}{{E}_{c}} ) * ( {P}_{G} - {E}_{C} )$$

P_{D}=Power Demand
E_{C}=Energy Consumption
P_{G}=Power Generation (Renewable Energy)
4. Cost (Life Cycle Cost—LCC)—for Individual Domain

$${\sum }_{i = 0}^{n} L C C = {\sum }_{i = 0}^{n} ( Invest + Replace + Opex + Main + Resi )$$

To be Calculated for Each Domain:
   Invest—Investment Cost
   Replace—Replacement Cost
   Opex—Operational Expenses
   Main—Maintenance Cost
   Resi—Residual Cost
5. Building Component Efficiency—Device/Sensor, Points, Algorithms, Routines, etc.

$$Efficiency = {\sum }_{i = 0}^{n} ( C + E + D + R + A + B )$$

C—Sensor/Device
E—Algorithm
D—Points
R—Routines
A—Adaptive
B—Balancing

At step 510, the analysis module 205 may determine impact of altering one or more parameters on the automation effectiveness score corresponding to each system and sub-system in the building. For this purpose, the analysis module 205 may transmit one or more instructions to alter one or more operational parameters of the sub-system in the building. The analysis module 205 may further repeat step 509 after altering the one or more operational parameters of the sub-system in the building. The new automation effectiveness score may be compared with the existing automation effectiveness score to determine the impact of altering the one or more operational parameters. In one embodiment, the process of determining impact analysis may be repeated multiple times in order to determine the best combination of operational parameters, such that maximum automation effectiveness score is achieved. In one embodiment, instead of randomly altering one or more operational parameters of the sub-system in the building, the analysis module 205 may enable an artificial intelligence system. The artificial intelligence system may compute a set of best possible combinations of operational parameters. For this purpose, the artificial intelligence system may rely on a machine learning program based on a training database associated with the artificial intelligence system. The training database may store historical information corresponding to the impact of altering one or more operational parameters of each automation system from the set of automation systems and each sub-system from the set of sub-systems corresponding to Building Management Systems (BMSs) 105 that are analysed in the past. As a result of applying Artificial Intelligence, the best automation effectiveness score can be computed with minimal number of permutations and combinations of the one or more parameters of each automation system and each sub-system corresponding to the Building Management System 105. Further, after the analysis is complete, the information corresponding to the analysis may be used for updating the training database associated with the Artificial Intelligence system.

At step 511, the recommendation module 206 may generate a detailed set of recommendations for improving automation effectiveness and building operations. The detailed set of recommendations may be generated based on different automation efficiency scores that are generated after altering the one or more operational parameters of the sub-system in the building as stated in step 510.

Although implementations for the system 101 and the method 500 for assessment of automation and control units implemented in a Building Management System (BMS) 105 of a building, have been described in language specific to structural features and methods, it must be understood that the claims are not limited to the specific features or methods described. Rather, the specific features and methods are disclosed as examples of implementations for the system 101 and the method 500 for assessment of the set of automation and control units implemented in the Building Management System (BMS) 105.

1. A system for assessing the effectiveness of automation systems implemented in a building for generating recommendations, the system comprising:
a memory;
a processor coupled to the memory, wherein the processor is configured to execute programmed instructions stored in the memory for,
receiving a metadata corresponding to a building, wherein the metadata corresponds to a location of the building, type of the building, and a set of automation systems and a set of sub-systems implemented in the building;
analysing the metadata corresponding to the building, based on a set of predefined parameters, to identify a building template applicable to the building, wherein the building template corresponds to a set of questions associated with the set of automation systems implemented in the building;
receiving inputs, from a building automation system, corresponding to each question from the set of assessment questions, wherein the set of questions correspond to the set of automation systems, System Control Routines corresponding to each automation system from the set of automation systems, the set of sub-systems corresponding to each automation system from the set of automation systems, Control Points corresponding to each sub-system from the set of sub-systems, Control Routines corresponding to each sub-system from the set of sub-systems, and Adaptive Control Routines corresponding to each sub-system from the set of sub-systems;
building a system tree corresponding to the building based on the received inputs from the building automation system, wherein the system tree is built using a neural network;
generating a set of assessment questions based on the metadata and the system tree;
receiving inputs from the building automation system corresponding to the set of assessment questions;
calculating an automation effectiveness score corresponding to each system and sub-system in the building, based on the received or read inputs from the building automation system corresponding to the set of assessment questions;
determining the impact of altering one or more parameters on the automation effectiveness score corresponding to each system and sub-system in the building; and
generating a set of recommendations for improving the automation effectiveness and building operations based on the impact of altering one or more parameters on the automation effectiveness score.

2. The system as claimed in claim 1, wherein the automation effectiveness is calculated based on determination of optimal number of sensors, systems, commissioned points, and optimization routines depending upon the metadata of the building and the system tree.

3. The system as claimed in claim 1, wherein the automation effectiveness is based on assignment of predefined weightages assigned to sensors, systems, sub-systems and optimization routines associated with the building.

4. The system as claimed in claim 1, wherein the automation effectiveness is computed based on a composite scope of automation effectiveness made by tabulating the weighted average scope of sensors, systems, sub-systems and optimization routines associated with the building.

5. The system as claimed in claim 1, wherein the memory comprises of a set of modules, wherein the set of modules consist of a system tree generation module, an analysis module, and a recommendation module.

6. The system as claimed in claim 5, wherein the analysis module comprises an artificial intelligence system, wherein the artificial intelligence system comprises machine learning enabled based on a training database, wherein the training database is configured to store historical information corresponding to the impact of altering the one or more parameters of each automation system from the set of automation systems and each sub-system from the set of sub-systems corresponding to a Building Management System analysed in the past.

7. The system as claimed in claim 6, wherein the artificial intelligence system is configured to compute a set of best possible combinations of parameters to be altered for determining the optimum automation effectiveness score.

8. The system as claimed in claim 5, wherein the recommendation module is configured to generate the set of recommendations based on different automation efficiency scores generated after altering the one or more parameters of each automation system from the set of automation systems and each sub-system from the set of sub-systems in the Building Management System.

9. The system as claimed in claim 1, wherein the set of questions include data enquiring questions, data reading commands or the like.

10. A method for assessing the effectiveness of automation systems implemented in a building for generating recommendation, the method comprises the steps of:
receiving a metadata corresponding to a building, wherein the metadata corresponds to a location of the building, type of the building and a set of automation systems and a set of sub-systems implemented in the building;
analysing the metadata corresponding to the building, based on a set of predefined parameters, to identify a Building template applicable to the building, wherein the building template corresponds to a set of questions associated with the set of automation systems implemented in the building;
receiving inputs, from a building automation system, corresponding to each question from the set of questions, wherein the set of questions correspond to the set of automation systems, System Control Routines corresponding to each automation system from the set of automation systems, the set of sub-systems corresponding to each automation system from the set of automation systems, Control Points corresponding to each sub-system from the set of sub-systems, Control Routines corresponding to each sub-system from the set of sub-systems, and Adaptive Control Routines corresponding to each sub-system from the set of sub-systems;
building a system tree corresponding to the building based on the received or read inputs from the computing device, wherein the system tree is built using a neural network;
generating a set of assessment question based on the metadata and the system tree;
receiving inputs from the building automation system corresponding to the set of assessment questions;
calculating an automation effectiveness score corresponding to each system and sub-system in the building, based on the received or read inputs from the computing device corresponding to the set of assessment questions;
determining the impact of altering one or more parameters on the automation effectiveness score corresponding to each system and sub-system in the building; and
generating a set of recommendations for improving the automation effectiveness and building operations based on the impact of altering one or more parameters on the automation effectiveness score.

11. The method as claimed in claim 10, wherein the automation effectiveness is calculated based on determination of optimal number of sensors, systems, commissioned points, and optimization routines depending upon the metadata of the building and the system tree.

12. The method as claimed in claim 10, wherein the automation effectiveness is based on assignment of predefined weightages assigned to sensors, systems, sub-systems and optimization routines associated with the building.

13. The method as claimed in claim 10, wherein the automation effectiveness is computed based on a composite scope of automation effectiveness made by tabulating the weighted average scope of sensors, systems, sub-systems and optimization routines associated with the building.

14. The method as claimed in claim 10, wherein generating the set of recommendations comprises generation of a detailed set of recommendations based on different automation efficiency scores generated after altering the one or more parameters of each automation system from the set of automation systems and each sub-system from the set of sub-systems in the Building Management System via the analysis module.

15. The method as claimed in claim 14, wherein the analysis module comprises the artificial intelligence system configured to compute a set of best possible combinations of parameters to be altered for determining the optimum automation effectiveness score via machine learning based on a training database.

16. The method as claimed in claim 10, wherein the set of questions include data enquiring questions, data reading commands or the like.
